(19) United States
(12) Patent Application Publication
(10) Pub. No.: US 2012/0120471 A1
(43) Pub. Date: May 17, 2012

(54) DISPLAY MODULE AND RELATED MANUFACTURING METHOD

(75) Inventors: Esa Hämäläinen, Tampere (FI); Hannu Karhuketo, Valkeakoski (FI); Jukka Enarvi, Tampere (FI)

(73) Assignee: MARISENSE OY, Vantaa (FI)

(21) Appl. No.: 12/918,983

(22) PCT Filed: Feb. 23, 2009
(86) PCT No.: PCT/FI09/50143

§ 371 Date: May 16, 2011

Related U.S. Application Data
(60) Provisional application No. 61/064,203, filed on Feb. 21, 2008.

(51) Int. Cl. G02F 1/01; B32B 37/14

(52) U.S. Cl. 359/238; 156/60

(57) ABSTRACT

A display device including a flexible display layer including display material. A flexible backplane layer has an electrode structure for driving the display material. A substantially rigid component having a thickness greater than a thickness of the flexible display layer and/or the thickness of the flexible backplane layer. A resilient layer has a cut-out space for the rigid component. The resilient layer is arranged to provide a substantially even total thickness of the device. The device also includes wireless communication capabilities.

### FIELD OF THE INVENTION

This invention relates to an encapsulated display module as defined in the attached independent patent claim 1. Further, the invention relates also to a method for encapsulating a display module as described in the attached independent claim 15.

### BACKGROUND

Electronically controllable compact display units find new and wider applications continuously. A well-known and a steadily growing field of applications can be found in stores and warehouses, where instead of conventional paper price labels on the shelves, the prices and other product related information is displayed using Electronic Shelf Labels (ESL). ESL's are particularly suitable for use in large shops or supermarkets that offer thousands or tens of thousands product items for sale, whose prices must be updated frequently and correctly.

According to the conventional technology, the price information on supermarket labels is changed manually using information printed on paper labels. New prices are printed out on paper or a similar sheet material and small labels are placed manually in corresponding holders on the shelves. This tedious method involves first finding the correct place for the updated price label, and then removing the old label and replacing it with a new label. This is very labour-intensive and also prone to human error. It also leaves possibility for information conflicts between prices on the shelves and prices stored in the scanners at checkouts.

To solve these problems, systems based on various electronic display technologies have been developed to be used as ESL's. These electronic displays can be updated from a centralised control system via wired or wireless communication. All-wired systems have obvious problems in terms of the layout limitations caused by complicated cabling due to the high number of individual ESL displays. Wireless systems have their major technological bottleneck in the need for individual power supplies for each ESL display unit and requirement for long power supply lifetime, i.e. operational lifetime for the batteries. In addition, the wireless systems need to be able to provide dependable communication channel in an environment that has high number of individual receiver-transmitter units that in order to prolong the battery life, need to operate with minimum transmitting power levels.

Liquid crystal display (LCD) technology is one of the display type used for such electronically controllable ESL displays. These have as their drawbacks rather high power consumption and visible appearance that does not resemble traditional paper displays. Also the encapsulation of such displays leads typically to rigid and conventional casings that are not optimal to be handled in the stores by the store personnel. Further, such fairly thick display devices contain also often glass windows which become easily damaged. ESL displays, which are thick and conventionally capsulated, require a specially manufactured, strong shelf rail system which is different from the one commonly used with paper labels. This means that structural modifications must be made to existing shelves, which creates unnecessary extra costs.

Another brand of display technologies suitable for ESL applications are Electronic Paper Displays (EPD) that possess a paper-like high contrast appearance, ultra-low power consumption, and a thin, light form. EPD's aim to give the viewer the experience of reading from paper, while providing the capability to electronically update the displayed information. EPD's are a technology enabled, as one possibility, by electronic ink. Such ink carries an electrical charge enabling it to be updated through electronics. Electronic ink is well suited for EPD's as it is a reflective technology which requires no front or backlight, is viewable under a wide range of lighting conditions, including direct sunlight, and requires no power to maintain an image. Electrical power is only consumed when the displayed data is changed. In order become widely applied in different type of applications, wireless ESL's or corresponding electronically controlled wireless displays are faced with a number of requirements that are partly dictated by the manufacturing process and partly by the end use, for example, the use, environment and manageability in a store by the store personnel.

From the manufacturing point of view, in the order to achieve truly low cost devices, a roll-to-roll or web-based manufacturing process would be preferred. This brings about severe limitations to the encapsulation of the ESL's to be suitable for such manufacturing methods, for example, due to the requirement a certain level of flexibility of the structures. Typically not all of the components required in an ESL and having cost and technical performance at acceptable level are nowadays available as mechanically flexible structures and this limitation would need to be somehow addressed in the manufacturing methods.

In order for the ESL's to be easily manageable during the manufacturing process and in the following logistical steps, the encapsulation of the ESL's need to provide a somewhat flexible structure against damage and preferably even thickness of the encapsulation or casing without any protruding or intending rims or order structures. Reasons for such requirements arise from, for example, simple and easy packaging and delivery of the items to the end user from the manufacturer, any preparations, automated or manual, needed for the ESL's to be used in the shelves (often also including adding conventional printed information on the ESL's) and installation/mounting of the ESL's on the shelves or holders therein. ESL's undergo a lot of handling during the preparation before they are installed to those substantially permanent final locations in the shelves. This make the requirements for these display modules clearly different from those of, for example, small sized electronic devices to be personally carried out in pockets etc. This also opens up more possibilities to choose materials as well in many cases relieves requirements for the size/dimensions of the devices.

Further, the structure and encapsulation of ESL's need to be such that the wireless communication with the control systems can be realized with minimal or negligible interference from the encapsulation itself or by the surrounding structures, such as the metal shelves that the ESL's are to be attached to in the shop.

In addition, the preferred shape of the encapsulated devices in some applications is not a straight card type shape, but in order to improve the visual appearance and readability, the ESL display can also have a slightly curved shape so that the displayed information appears on the outwards curved surface. Further, in many applications the extreme thinness of the product might not be preferable, because it can complicate the handling of ESL's.

It is clear, that none of the existing prior art display devices and related encapsulation methods is able to satisfy the numerous above mentioned requirements that are in some extend somewhat conflicting with each other. Therefore, there is a clear need for further inventive development in this area.

### SUMMARY

The aim of the current invention is to provide a novel and inventive encapsulation structure for ESL's and corresponding electronically controllable displays to better meet simultaneously the above listed requirements both regarding the manufacturing and final use of the display modules. Further, the aim of the invention is to provide also the manufacturing method to obtain such display modules.

The main benefits of the display modules according to the invention lie in the mechanical resistance of substantially thin and flexible display module laminates against mechanical impacts, as well as in the completely smooth outer surface and even thickness to aid overall manageability. Further, the encapsulation technique according to the invention results in casings that have good performance in respect to the wireless communication using an internal antenna. A further benefit is the fact that the visual appearance of the ESL's resembles paper sheets or paper labels that are familiar for the customers and that can also be placed in the same type of holders, pockets or space as the conventional paper labels. The solution according to the invention also allows using such energy source, for example, battery solutions, that provide long operational lifetimes without high cost that would be inherent for more exotic battery technologies.

Both the mechanical (robustness, handling properties) and visual appearance of the display units according to the invention are much improved from the state of the art devices and also the manufacturing method provides benefits of roll-to-roll or web-type manufacturing to ensure low cost.

Below, the invention is described in detail using application examples, by referring to the appended figures.

### BRIEF DESCRIPTION OF THE DRAWINGS

FIG. 1 shows a generic example of a shop system using ESL displays,

FIG. 2 shows an ESL module according to the invention together with a plastic shelf holder,

FIG. 3 an ESL module according to the invention in a three-dimensional view to show the curvature of the module,

FIG. 4 an ESL module according to the invention showing the additional printed and self-adhesive label and a dual-purpose cut-out in the module,

FIG. 5 shows a schematic process description to manufacture an ESL,

FIG. 6 shows a schematic process description to manufacture an ESL,

FIG. 7 shows a schematic exploded three-dimensional view showing different layers of an ESL, and

FIG. 8 shows a schematic cross-sectional diagram showing the structure of an ESL.

### DETAILED DESCRIPTION

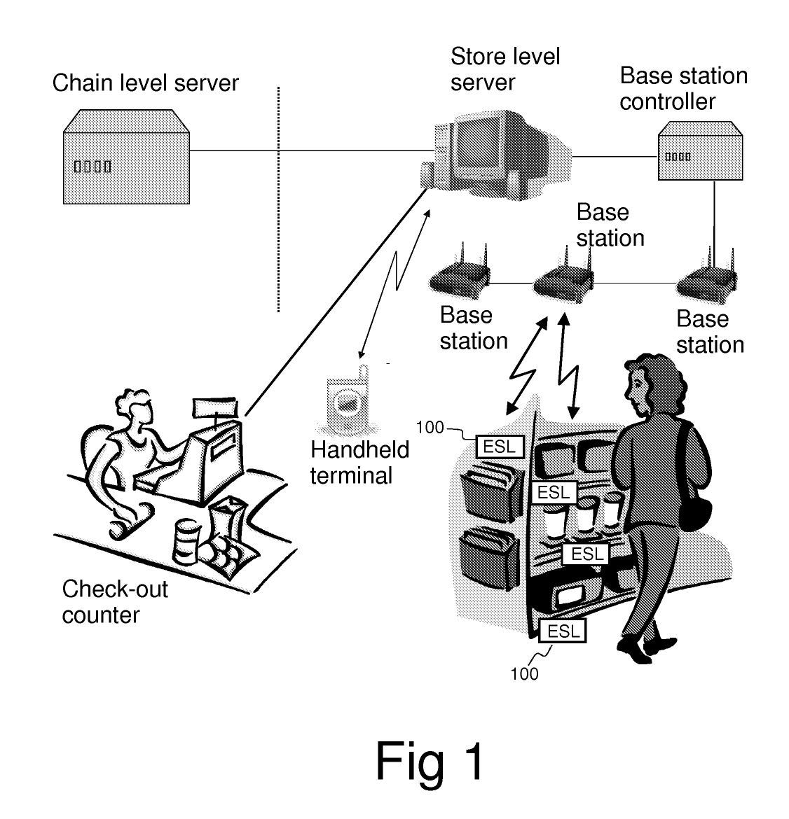

FIG. 1 shows schematically, as an example, a typical arrangement of the use of ESL displays in a supermarket or similar sale environment.

Shelves are equipped with ESL displays that are typically attached in shelf rails carrying plastic ESL holders. ESL displays are placed in locations corresponding to the products on the shelves to be easily perceivable for the customers.

ESL displays communicate in a wireless manner with the base stations shown in FIG. 1. This wireless communication method may be based on any known wireless communication technology, but in order to save battery life of the ESL modules, passive backscatter radio communication is preferred. In this approach the base stations actively send radio signals and instead of answering with active radio transmission, the ESL modules do not use a radio transmitter; instead, they answer by modulating the reflected power of the base station signal. The modulation is achieved, typically, by changing the load state of the ESL antenna in the ESL module, for example, by connecting and disconnecting the antenna between the ground and non-ground potential. This modulation of the backscattered signal allows for the ESL modules to answer to the base stations and further to the store level server.

Each ESL module can be identified by its own identification code that the ESL module in question knows to listen for in the transmission from the base station. After receiving new information, instructions or commands from the store server via bases station, the ESL module can acknowledge the reception of these instructions by using the reflected backscattering modulated properly and timely for the store level server to identify that the response is coming from the ESL module is question. To facilitate that the store server may have a certain listening period after a transmission directed to a certain ESL module for giving the module possibility to answer during that time.

Base stations are typically connected in a wired manner, for example, via Ethernet connection to a base station controller. This base station controller is further connected to a store level server containing the price and other product information.

When price information is changed in the store level server locally according to pre-programmed instructions therein or manually by the shopkeeper or, remotely, from instructions received from a store chain level server, this information will be delivered through the base stations to individual ESL displays.

The corresponding price information is also made available to the check-out counter that is arranged in communication with the store level server. A further possibility for modifying the content of the information send to individual ESL displays is the use of a handheld terminal also shown in FIG. 1. A handheld terminal can be used by a member of the shop staff allowing him/her to freely move around in the shop and communicate in a wireless manner with the store level server. This communication can be achieved, for example, via a GSM or GPRS network allowing using Personal Digital Assistant (PDA) type computing devices with inherent wireless communication capabilities. The handheld terminal can contain only limited functionalities or depending on the processing power of the device, it can be used to control the full capabilities of the application running in the store level server. In some applications in smaller shops with a fewer number of ESL displays, a handheld terminal may be used instead of a separate store level server.

Further, the shop level server can be in connection with a chain level server that can provide identical price and product information to several stores belonging to the same chain of stores.

It is clear for a person skilled in the art that the software applications, communicational functions and other functions of the system described schematically in FIG. 1 can be arranged in a wide variety of different ways depending on the details of the application in question. FIG. 1 only aims to provide a high level illustration as an example to aid for understanding the benefits of the invention described here.

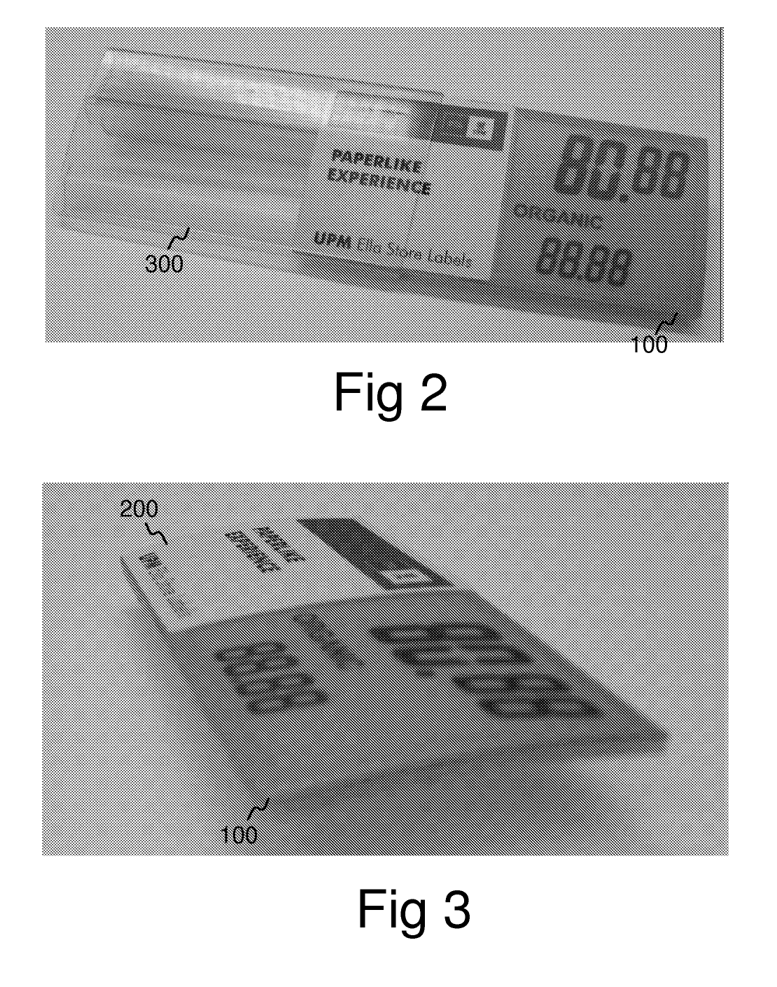

FIG. 2 shows schematically an ESL display together with a plastic holder 300 the display module partly pushed inside the holder 300. The holder 300 can be attached, typically, to the front rail of a shelf and facilitates easy installation of the ESL display. The holder 300 can have various shapes and sizes and manufactured from pressed or extruded plastic, for example. The holder 300 may clip into the shelf rail or it can also be attached, for example, using adhesive such as with double-sided tape. The ESL module may also be attached directly to the shelf or to a self edge rail other structure without a separate holder 300 depending on the application.

In the example embodiment in FIG. 2, the size of the ESL module is approximately 90 mm (width)×45 mm (height)×2 mm (thickness). This gives the display module, or label a convenient size for convenient manual handling, occupying a suitably sized space in the shelf and also large enough text and numbers to be easily visible for a customer. The above dimensions are just exemplary giving idea of the size class of the module. The size of the modules according to the invention can vary from these according to the application in question.

FIG. 3 shows the same ESL module as in FIG. 2 but from a different perspective to more clearly show the curvature of the label. This is a preferred shape in many applications, especially in stores and warehouses. The ESL display together with the plastic holder 300 being slightly outwards curved towards the customer gives more pleasing outer appearance and also better perceptivity than entirely straight structure. It is also possible to provide the curvature in other direction, thus, providing an ESL module that is curved inwards. This can be preferred in some applications making, for example, different type of display module holder 300 designs possible.

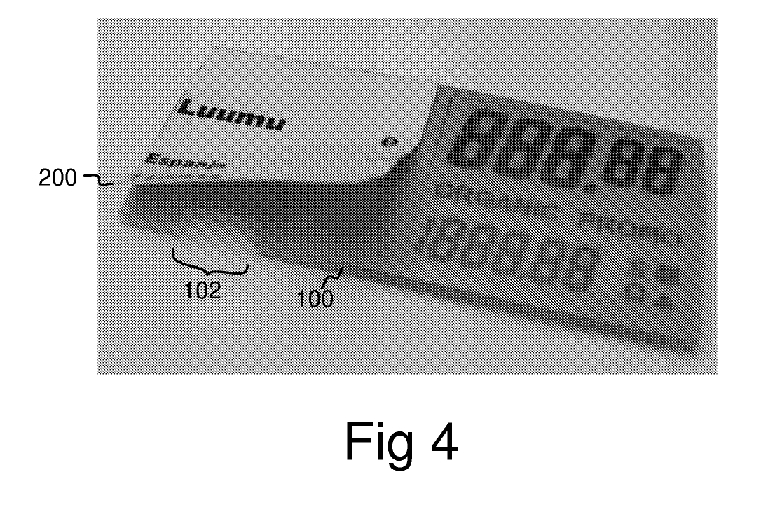

FIG. 4 shows further one possible embodiment of an ESL according the invention and especially usable together with separate holders 300. The ESL module in FIG. 4 shows a partly removed printed label on the ESL module disclosing a dual-purpose cut-out 102 in the side of the module structure 100. The functions of this cut-out 102 are explained in more detail below. Again, the dimensions or the curvature of the module in FIG. 4 could have been selected otherwise depending on the application.

Typically, an ESL module contains a separate printed label carrying shop and/or product logos, product name and/or trademark, package size or other information of more permanent nature. Because this information does not need to be updated very frequently, it can be added to the ESL label in the form of self-adhesive printed label in order to minimize the requirements and cost of the display unit in the ESL label. However, such a label may need changing every now and then and thus also this work phase needs to be made as easy as possible. Removal of a large number of printed labels from the ESL modules can present a frustrating and non-productive work load for the shop operators especially in large shops.

The cut-out 102 showed in FIG. 4 provides significant help when manually or automatically removing a printed sticker label from the ESL label. This becomes very important especially when the label removal and new label indentation are to be automated and/or when the store logo is changed and the labels in the whole store need to be changed in a short period of time. This can happen, for example, in a case of business owner changing or other type of reuse of ESL modules.

The end users, for example shopkeepers, also expect the ESL modules/labels to be fixed to the store shelves in a manner sufficient to prevent them to be too easily removable by unauthorized persons, for example, by the store customers. Therefore, the other purpose of the dual-purpose cut-out 102 in the ESL module 100 as shown in FIG. 4 is to provide a method for locking the ESL module 100 into it's holder 300. A latch type locking means is arranged in the holder 300 and to enter the cavity or cut-out in the ESL module to fix the position of the ESL to the label holder 300. The locking means, clip mechanism, makes it difficult enough for an outsider to remove the ESL from the holder 300 quickly and unnoticeable, because when the adhesive printed label 200 is in place, the clip is positioned behind the printed label 200 and not visible from the front side of the ESL module.

Thus the cut-out 102 according to the invention solves two problems. First the ESL labels might be stolen or removed from the store shelves by customers too easily without the locking capability provided by the cut-out 102. Secondly, removal of the printed label 200 from the ESL would be time consuming and annoying work without the help provided by the cut-out 102 by giving a starting point for the removal.

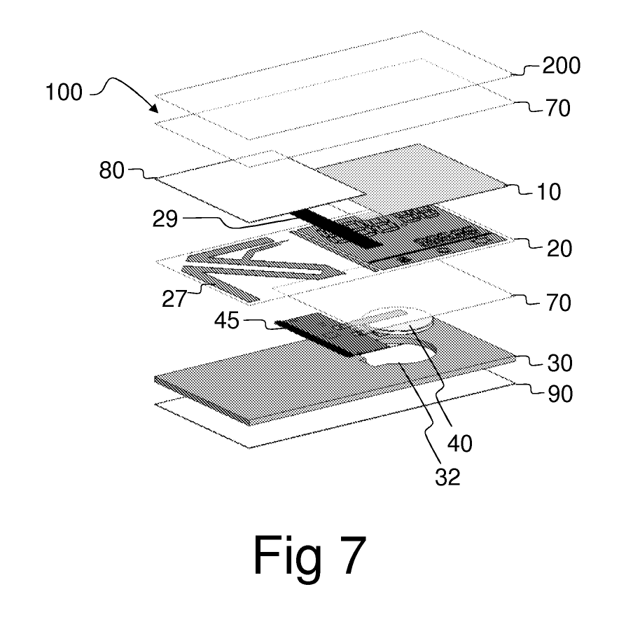

Preferably the cut-out 102 will be cut to the antenna side of the ESL label (antenna location explained later in more detail and shown in FIG. 7) at the same time when the ESL modules 100 are cut off from the continuous reel or web of products in the roll-to-roll type manufacturing process. It will add no extra cost to the product 100. The cut-out 102 will be hidden when a printed paper adhesive label 200 without a cut-out is placed on top of the ESL front surface. Of course, it is possible also to locate the cut-out 102 in different manner, but all locations of the cut-out 102 do not provide the dual-purpose benefit explained above.

The clip in the ESL holder 300 can be arranged in a number of ways. For example, if the holder is manufactured via a plastic extrusion process, a cost effective manner to do this is to saw a clip into the holder 300. The final shape of the clip together with required tension for the clip to protrude into the cut-out 102 can be made with normal plastic tooling. The final shape of the clip will allow easy the lifting off the clip by a competent shop operator who knows the location and function of the clip and this way the effective method for releasing of the ESL module/label from its holder 300.

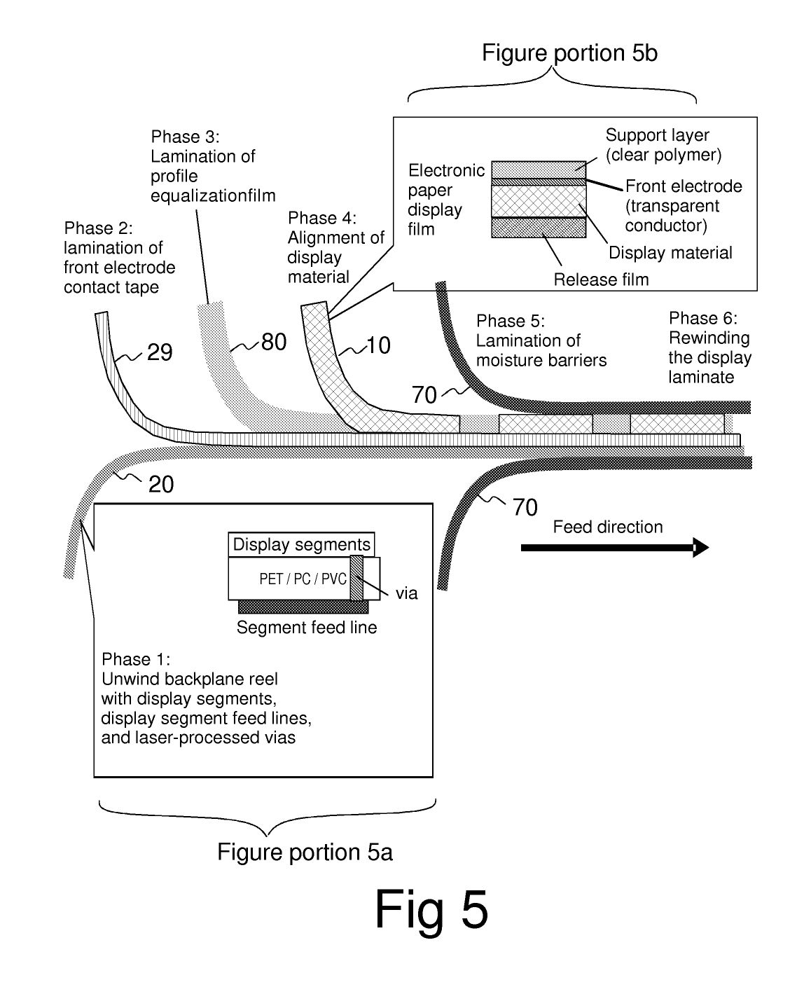

In the following the manufacturing method and structure of the display module encapsulation according to the invention is described in more detail using an ESL display module as an example and making reference to FIGS. 5-8.

FIG. 5 describes the first phases of the web-type or roll-to-roll manufacturing method according to the invention making it possible to manufacture and encapsulate the display modules 100 in fast and economical manner without compromising the properties of the end product.

In FIG. 5 the manufacturing starts in phase 1 by providing a backplane 20 having patterned electrode structure on the top surface as a base web. Typically, this patterned backplane is a plastic film (PET or PC or PVC) with patterned conductive layer on the top and bottom surfaces (see details in Figure portion 5a). The forming and patterning of the conductors can be made using any method known as such for a person skilled in the art, for example by direct printing of conductive ink or by etching of a thin metal layer. The lower surface of the backplane has display segment feed lines patterned in a similar way. Each display segment is electrically connected to a corresponding display segment feed line through a preferably laser processed via. Also other ways of providing feed-through via's are possible as is evident for a person skilled in the art.

In phase 2, in order to establish an electrical contact from the backplane segments to the display front electrode, that is in this example on the front surface of the flexible electronic display web (see details in Figure portion 5b), an electrically conducting tape 29 is laminated on the backplane area acting as a front electrode feed line. The location of the electrically conducting tape 29 is shown more clearly in the FIG. 7 showing an exploded view of the laminated encapsulation structure of an ESL module 100. Alternatively and instead of an electrically conducting tape 29, electrically conducting paste or similar material with adhesive nature may be dispensed on the backplane web to make contact with the front plane electrodes.

In phase 3, a profile equalization film 80 is laminated on backplane 20 in order to maintain good processability of the web by equalizing the total thickness of the structure of the electronic display label 100 when the electronic display web is laminated onto the structure. This is needed because the display material/laminate 10 is only partly covering the backplane web as shown more clearly in FIG. 7. In addition, the profile equalizing film 80 helps to obtain even thickness and smooth front (and back) surface for the end product 100. Phase 3 is performed by laminating a film 80 with similar thickness to that of the electronic display web 10 (e-paper display film) to the area on the backplane 20 which is not covered by the display 10. This may be done immediately before or also after the lamination of the display film 10, or simultaneously with it. As equalizing film 80 basically many type of flexible materials can be used, for example PET film, that also provides heat stability needed in if the successive electronic components or modules are heat bonded to the structure.

In phase 4 the electronic flexible display material 10, for example e-paper display, is laminated onto the backplane base web 20 as pre-sized display labels. In this phase, display material 10 can be provided as pre-sized display labels on a continuous release film acting as a web (see FIG. 5b for more details), or it is also possible to feed the display labels 10 to the base web 20 individually from a stack of separate labels.

Electronic paper display film 10 typically consists of electrophoretic, electrochromic or similar material on a polymer substrate (typically Polyethylene terephthalate, PET) coated with transparent conductor (typically indium tin oxide, ITO) which forms the front electrode. When electronic paper film 10 is placed on a backplane 20, which may be a segmented conductor layer or a matrix type backplane and both the backplane, and the front electrode of the electronic paper film 10 are connected to a driving electronic circuit, the display can be driven by applying a voltage between the back and electrodes. To establish an electrical contact between the continuous transparent front electrode on the display film 10 and the equivalent driving electrode on the backplane 20, it is necessary to remove display material within certain region from one edge of the label. Further, accurate alignment of the display labels 10 both in machine direction and cross direction are necessary in phase 4.

After laminating the display labels 10 with the incorporated front electrodes in phase 4 on the backplane base web 20, in phase 5 moisture barriers 70 are laminated both on the bottom and top of the web structure. Electronic paper display materials are generally rather sensitive to moisture variations so it is usually necessary to encapsulate the display material 10 inside moisture barriers 70. This is according to the invention done by laminating moisture barrier film 70 on both sides of the display web 10. Such barriers may be made of, for example, fluoropolymers or plastic materials coated by vacuum sputtered metal or silica layers. The lower moisture barrier 70 may be non-transparent, but the upper barrier 70 needs to be transparent.

After phases 1-5 in FIG. 5 a continuous and flexible display laminate web with substantially even thickness has been formed and it can be re-winded to a roll to wait next processing phases or, as one possibility, channeled directly towards the next processing phases necessary to finalize the encapsulation of complete electronically controlled display modules. According to the current invention, in the first phases, a flexible display laminate web, an important intermediate product, is produced from mainly web-shaped components and films to provide convenient starting point for the finalizing phases.

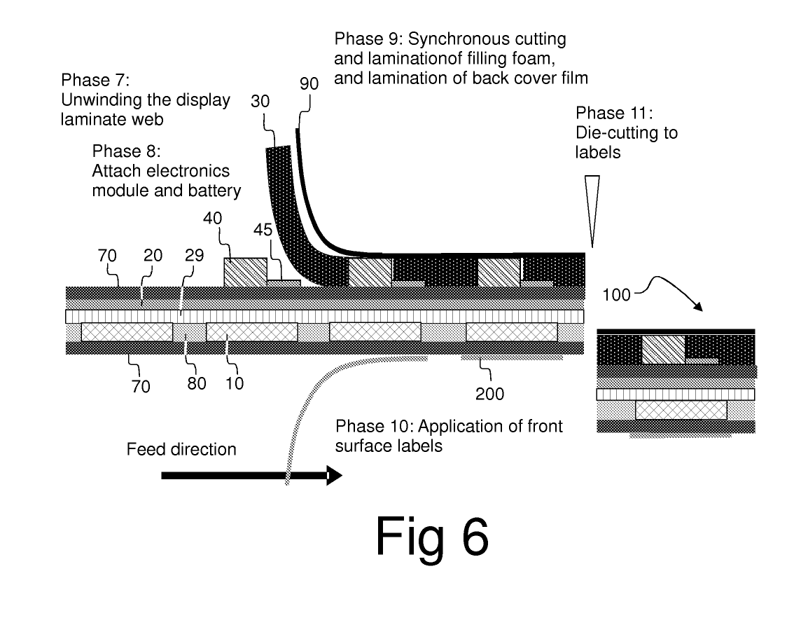

FIG. 6 describes schematically the next manufacturing phases that use the display laminate produced from the earlier phases as a web-shaped starting point.

In order to function as an electronic display module in a specific application, such as an ESL display, the module needs to be equipped with a microelectronic circuitry having display driving, data processing and communication functions and also with a power source. Because of the high resolution and accuracy required in such electronic circuit wirings, it is advantageous to manufacture this circuitry using well-known methods for flexible printed wired board (PWB) manufacturing techniques based, for example, using polyimide substrates, photolithographic patterning of the substrates and automatic component placing. These processes are typically sheet-based although roll-to-roll processes are also nowadays emerging. Because of these reasons, manufacturing cost per unit area of the flexible PWB containing microelectronic components becomes higher than that of the simpler backplane web. Thus it is advantageous to minimize the size of the circuitry, manufacture it separately as a sub-module and attach it to the backplane web in a roll-to-roll process.

Although thin and flexible battery technologies already exist nowadays, they are still far away from providing the electrical power capacity and shelf life required by applications such as ESL modules. Because of this, it is necessary to use conventional coin-shaped batteries as an economical and high-capacity power sources.

In order to keep the number component placement steps at minimum, a battery providing power for the label can be attached to the PWB circuitry and attached then together in a single step to backplane web as a sub-module. The electronics sub-module has to be precisely aligned with the display segment feed lines and then attached to them permanently and reliably. This can be accomplished by placing the sub-module with a robot or component placer and bonding it using heat activated anisotropic conductive film, paste or similar adhesive.

Of course, it is also possible to attach the electronic components including the energy source directly to the backplane without use of a separate sub-module, but in many cases most cost effective solution is achieved by minimizing the size of the required PWB. This is especially true in case of larger size display modules

Thus, preferably a sub-module based on conventional flexible PWB is formed and arranged ready to be joined with the flexible display laminate in a roll-to-roll or web-type manufacturing process. Preferably, this sub-module also contains a battery unit with high enough capacity to provide long storage and use times. The invention is however not limited to this solution and other ways to connect the electrical components to the backplane and/or display material are also possible.

FIG. 6 shows schematically how the above described flexible display laminate is joined with the flexible PWB electronic sub-module 45 into a finalized product.

In phase 7, the display laminate is un-winded from the reel the display facing now downwards.

In phase 8 the electronic sub-module 45 together with the battery 40 is automatically positioned and attached to the backside of the display laminate. This phase can utilize any technique known as such for a person skilled in the art.

Because the electronic sub-module 45 attached in the phase 8 contains sensitive microelectronic circuits and components that as such are not flexible even if attached to a flexible PWB, it is necessary to encapsulate the electronic display module 100 in such a way that the completed module provides some mechanical protection against the mechanical stresses, but still maintains a certain level of flexibility. Further, as mentioned earlier, an important feature of the module is that the module has even thickness without any protruding or intending rims or order structures. It should also be noted that typically the electronics sub-module 45 contains electronic components and especially a battery 40 that are much thicker (typically 1-3 mm) than the display laminate (typically 0.2-0.6 mm). Traditionally, such an electronic display product with a total thickness of 1.5-4 mm would have required a separate plastic enclosure, manufactured by injection molding or similar process, and the product should be placed inside the enclosure in a separate process. As this would significantly add the manufacturing cost and as it would not be compatible with the otherwise roll-to-roll type processing, the new encapsulation method according to the invention provides significant development over the prior art.

In phase 9 in FIG. 6 the electronic modules being manufactured are encapsulated using elastic plastic encapsulation foam 30 in a combined synchronous cutting and lamination process. This resilient layer 30 has thickness and cut-out spaces 32 to accommodate the height of the substantially rigid electrical components 40 in order to obtain substantially even total thickness of the structure over the encapsulated area.

Foam 30 having a thickness similar to that of the thickest components in the electronics module (normally the coin battery 40) is preferably unwind from a roll, perforated using a laser cutting system synchronously with the display web and laminated in a nip so that the cut holes 32 in the foam (See FIG. 7) are aligned with the thick components in the electronic labels. Simultaneously or immediately after, a thin protective film 90 is laminated on top of the foam 30 to seal the back side of the label. The battery 40 and other electronic components thus become completely encapsulated in cavities formed by the foam and the back cover film 90. The foam 30 provides electrical insulation and protection from mechanical stress and shocks while keeping the electronic labels 100 processable in a roll-to-roll process. The adhesive on the foam 30 also binds the display part and the electronics module 45 together providing additional rigidity while maintaining flexibility of the label 100.

The foam 30 can be polymer material or any material having suitable dielectric properties to maintain the electrical functionalities and especially the radio-wave transmission properties of the display module 100. The benefits of using a foam material are also related to the low weight of the material having low density.

Foam material can selected from, but not limited to, polyolefin foam (polyethylene or polypropylene), polyurethane, or, polystyrene.

In addition to protecting components from mechanical shocks and stresses, the relative thick foam layer 30 also helps to create distance between the antenna 27 on the backplane (see FIG. 7) and possible metal structures on the shelves or shelf rails. This is important in order to create suitable environment for the radio communication to function without interference created by the close proximity metal or corresponding structures.

Of course, instead of synchronous cutting and lamination, foam components 30 could be provided as pre-shaped and stacked items that are positioned otherwise on the base web. However the continuous cutting and lamination provides clear benefits and ensures correct positioning of the foam cut-outs 32 intended for the electrical components 40.

In phase 10 to provide optional, desired visual effects, partially transparent, printed or otherwise patterned labels 200 are applied on top of each electronic label. The label 200 may have customer-specific printing such as logos or colour features and display enhancing properties such as anti-reflection properties etc.

In phase 11 the continuous web-shaped product is die cut into individual labels 100. Because the laser-perforated foam 30 provides encapsulation for the electronic labels, no additional packaging process after this is necessary. In the final step, the ready-made labels 100 are separated from the display web simply by die cutting.

FIG. 7 describes in a schematic exploded 3-dimensional view the different components and layers explained above. The naming of the components in FIG. 7 is congruent with the explanation given above. An antenna 27 required for the wireless communication is shown in FIG. 7 as having been formed on the backplane 20 together with the conductors required to drive the e-ink display.

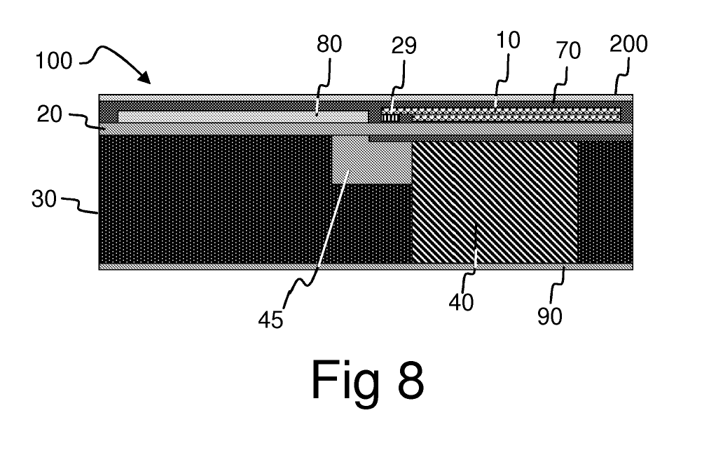

FIG. 8 further describes in a schematic cross-sectional view the structure of an ESL according to the invention. Again, the naming of the components is similar than in the earlier Figs and in the explanation above.

The lamination of the product in phases 1-10 as described above requires use of adhesives or glues. It is clear for a person skilled in the art that these materials providing the adhesion may be provided on either or both of the surfaces to be laminated together. The adhesives may be activated by heat, light, radiation or any other means as such.

As a further advantage, the manufacturing process according to the invention gives possibility to manufacture display labels that can be made curved in shape as shown in FIG. 3. This can be done by adjusting the tension between the different laminated layers together with proper selection of materials. The upper surface of the display label 100 may be e.g. convex or concave.

The invention provides possibility to manufacture display module structures that despite of their significant thickness, at least more than 1 mm but typically in the range of 2 mm, have certain amount of flexibility and still maintain well their original shape, Further, the encapsulated display modules 100 can be made very light compared to their size, which makes the convenient and easy to handle both manually and automatically.

In prior art products and encapsulation methods, increasing thickness typically decreases the flexibility, whereas in the products according to the invention the flexibility and the benefits therein are preserved better even if conventional rigid components 40 are to be used as a part of the device 100.

It will be obvious to those skilled in the art that the structure and shape of the display module 100 can vary from the descriptions given above. Also the details of the manufacturing process and the components used can vary according to the application. For example, use of additional layers or components is possible.

For example, the wireless communication method of the electronically controllable display modules 100 may be other than based on radio backscattering techniques. Active radio-wave, optical or other transmission methods are also possible.

The selection of display technology is basically limited only based on the thickness of the display structures and suitability for roll-to-roll type manufacturing requiring certain level of flexibility. The active display material 10 could consist of any electrophoretic material or of a display consisting of rotating dichromatic particles. The display material 10 could also be an electrochromic or liquid crystal material, or the display laminate could be created out of light-emitting display materials 10 such as electroluminescent displays or organic light emitting diodes. Generally speaking, any display materials 10 which can be used to create thin, paper-like displays are suitable for use in the invention. It will also be obvious to those skilled in the art that instead of display segments of a certain shape and instead of the segment control process, matrix displays can be used which are controlled by a matrix controller. In this case, instead of individual display segments, there would be several small matrix-shaped elements which are controlled with the matrix control principle, such that there is only one control conductor and one driver for each row and column of elements.

The various aspects of the invention are further illustrated by the following examples.

### Example 1

Encapsulated, electronically controlled display module with wireless communication capabilities, characterized in that the module comprises at least the following:

thin and flexible backplane with electrode structure for display driving,
thin and flexible display material layer arranged in a laminated manner into operational connection with the flexible backplane,
one or more substantially rigid electrical components having thickness significantly larger than the thickness of said flexible backplane or said flexible display material,
elastic layer with thickness and cut-out spaces to accommodate the height of said substantially rigid electrical components in order to obtain substantially even total thickness of the structure over the encapsulated area, and
protective outer layers on at least top and bottom surfaces of the structure.

### Example 2

Module according to example 1, characterized in that one or more of the substantially rigid electrical components having thickness significantly larger than the thickness of said flexible backplane or said flexible display material are provided on a separate flexible printed wire board submodule.

### Example 3

Module according to example 1 or 2, characterized in that at least one of the substantially rigid electrical components is an energy source.

### Example 4

Module according to example 3, characterized in that said energy source is a battery, for example, a coin-shaped battery.

### Example 5

Module according to example 1, characterized in that the total thickness of the structure is at least 1 mm.

### Example 6

Module according to example 1, characterized in that the module has a curved shape.

### Example 7

Module according to example 1, characterized in that the module is an Electronic Shelf Label, ESL module.

### Example 8

Module according to example 1, characterized in that the module is shaped to be placed in a separate holder.

### Example 9

Module according to example 1, characterized in that the module is shaped to adopt a printed label on the surface common to that of the electronically controlled display.

### Example 10

Module according to example 8 and 9, characterized in that the module has an outer surface cut-out for locking the module into a holder and helping to release the printed label from the module the cut-out located in a manner that it substantially covered by the printed label when said label is attached to the module.

### Example 11

Method for encapsulating an electronically controlled display module with wireless communication capabilities, characterized in that the method at least the following steps:

providing a thin and flexible backplane with electrode structure for display driving as a base web,
providing thin and flexible display material layer and laminating it into operational connection with the base web,
providing one or more substantially rigid electrical components having thickness significantly larger than the thickness of said flexible backplane or said flexible display material and providing them into operational connection with the base web,
providing elastic layer with thickness and cut-out spaces to accommodate the height of said substantially rigid electrical components and laminating the elastic layer on the base web in order to obtain substantially even total thickness of the structure over the encapsulated area, and
laminating protective outer layers on at least top and bottom surfaces of the structure.

### Example 12

Method according to example 11, characterized in that the process steps comprise at least one intermediate roll-to-roll phase and corresponding rewinding phase.

The display material 10 of the device 100 may be implemented by electronic ink.

Even if the encapsulation and manufacturing method according to the invention was explained above using an ESL display module as an example, the invention is not limited to ESL applications only, but the display modules according to the invention can find also use in other applications within the scope of the attached examples and claims.

1. A display device, comprising:
a flexible display layer comprising display material,
a flexible backplane layer having an electrode structure for driving said display material,
a substantially rigid component, wherein a thickness of said rigid component is greater than a thickness of said flexible display layer and/or a thickness of said flexible backplane layer,
a resilient layer having a cut-out space for said rigid component, wherein said resilient layer is arranged to provide a substantially even total thickness of said device, and
wireless communication capabilities.

2. The device according to claim 1, wherein said rigid component has been encapsulated in said cut-out space by laminating said layers together.

3. The device of according to claim 1, wherein said display layer, said back-plane layer, said resilient layer, and said rigid component are located between two protective layers.

4. The device according to claim 1, wherein said rigid component has been attached to a flexible printed wire board submodule.

5. The device according to claim 1, wherein said rigid component is an energy source.

6. The device according to claim 5, wherein said rigid component is a battery.

7. The device according to claim 6, wherein said battery has a circular shape.

8. The device according to claim 1, wherein the total thickness of said device is greater than or equal to 1 mm.

9. The device according to claim 1, wherein said device has a curved shape.

10. The device according to claim 1, wherein said device is an electronic shelf label.

11. The device according to claim 1, wherein said device has such a shape that fits into a holder.

12. The device (100) according to claim 1, wherein said device has a surface onto which a printed label can be attached such that said printed label and a controllable part of said display material are simultaneously visible to a viewer.

13. The device according to claim 1, further comprising:
a cut-out for locking said device into a holder.

14. The device according to claim 1, wherein said cut-out is arranged to facilitate releasing a printed label from said device when said printed label has been attached to said device such that said printed label at least partially covers said cut-out.

15. A method for producing a device comprising a flexible display layer comprising display material, a flexible backplane layer having an electrode structure for driving said display material, a substantially rigid component, wherein the thickness of said rigid component is greater than the thickness of said flexible display layer and/or the thickness of said flexible backplane layer, a resilient layer having a cut-out space for said rigid component, wherein said resilient layer is arranged to provide a substantially even total thickness of said device, and wireless communication capabilities, said method comprising:
providing said flexible backplane layer as a web, and
laminating said layers together.

16. The method according to claim 15, further comprising:
at least one roll-to-roll phase and a corresponding rewinding phase.
